(19) United States
(12) Patent Application Publication
(10) Pub. No.: US 2011/0093712 A1
(43) Pub. Date: Apr. 21, 2011

(54) COMMUNICATION DEVICE SUPPORTING PAIRING

(75) Inventors: Weon Il JIN, Suwon-si (KR); Hwan Joon KIM, Seoul (KR); Eunah KIM, Seoul (KR)

(73) Assignee: SAMSUNG ELECTRONICS CO., LTD., Suwon-si (KR)

(21) Appl. No.: 12/819,507

(22) Filed: Jun. 21, 2010

(30) Foreign Application Priority Data
Oct. 21, 2009 (KR) 10-2009-0100151

(51) Int. Cl. H04L 9/32

(52) U.S. Cl. 713/171

(57) ABSTRACT

Provided is a communication device. The communication device may transmit information to an external device using a terminal that makes a physical contact with the external device, and may sense the physical contact. In response to the sensed physical contact, the communication device may generate a link key.

### CROSS-REFERENCE TO RELATED APPLICATION(S)

This application claims the benefit under 35 U.S.C. §119(a) of Korean Patent Application No. 10-2009-0100151, filed on Oct. 21, 2009, in the Korean Intellectual Property Office, the entire disclosure of which is incorporated herein by reference for all purposes.

### BACKGROUND

1. Field

The following description relates to a communication device, and more particularly, to a communication device that may support a pairing having an excellent security.

2. Description of Related Art

Bluetooth technology is one of several short distance radio communication technologies that may support a voice communication and a data communication between various types of devices within a certain range. Since Bluetooth technology may minimize interference and fading from neighboring devices using the same frequency range, it may be possible to conveniently transmit data.

Bluetooth technology supports both a circuit switching system and a packet switching system and thus may enable both a data communication susceptible to a time delay, for example, voice and audio, and a data packet communication that is fast and relatively insusceptible to the time delay. A Bluetooth system may provide a one-to-one contact service or one-to-many contact service. In the case of the one-to-many contact service, a plurality of Bluetooth devices may share a communication channel.

At least two Bluetooth devices may share the communication channel. Any one Bluetooth device may function as a master that makes a pairing request, and another Bluetooth device may function as a slave that accepts the pairing request.

However, a security issue may arise when communicating via a Bluetooth connection. For example, an unauthorized user or device, within range of the Bluetooth devices may remotely attack the communication between a master communication and slave communication device by spoofing the slave communication device. Thus, the unauthorized user or device may be able to collect the data being transmitted via the Bluetooth connection.

### SUMMARY

In one general aspect, there is provided a communication device comprising a terminal, a sensing unit configured to sense a physical contact between the terminal and an external device, and a processor configured to generate a first key in response to sensed physical contact, to transfer the first key to the external device, to receive a second key from the external key, and to generate a link key using the first key and the second key.

The processor may transfer the first key to the external device via the terminal, and receive the second key from the external device via the terminal.

The physical contact may be maintained until the first key is transferred to the external device, and the second key is received from the external device.

The processor may include a seed generator configured to generate a seed key in response to the sensed physical contact, and a random number generator configured to randomly generate the first key using the seed key.

The processor may generate the link key by performing an exclusive OR (XOR) operation for the first key and the second key.

In another aspect there is provided a communication device comprising a terminal, a key generator configured to generate a first key in response to sensing a physical contact between the terminal and an external device, a data transmission controller configured to transmit, via the terminal, the first key to the external device contacting the terminal, and to receive a second key from the external device via the terminal, and a secret key generator configured to generate a first link key using the first key and the second key.

The key generator may include a seed generator configured to generate a seed key using a current time, a contact sensing unit configured to transmit a signal to the seed generator in response to the sensed physical contact, and a random number generator configured to randomly generate the first key using the seed key.

In still another aspect, there is provided a communication system comprising a first communication device including a first terminal and a second communication device including a second terminal. The first communication device and the second communication device are paired with each other by physical contact between the terminal of the first communication device and the terminal of the second communication device, to thereby enable communication between the first communication device and second communication device.

The first communication device may further include a first key generator configured to generate a first key in response to sensing a physical contact between the first communication device terminal and the second communication device, a first data transmission controller configured to transmit, via the first communication device terminal, the first key to the second communication device, and to receive a second key from the second communication device via the first communication device terminal, and a first secret key generator configured to generate a first link key using the first key and the second key.

The second communication device may further include a second key generator configured to generate a second key in response to sensing a physical contact between the second communication device terminal and the first communication device, a second data transmission controller configured to transmit, via the second communication device terminal, the second key to the first communication device, and to receive the first key from the first communication device via the second communication device terminal, and a second secret key generator configured to generate a second link key using the first key and the second key.

Other features and aspects will be apparent from the following detailed description, the drawings, and the claims.

### BRIEF DESCRIPTION OF THE DRAWINGS

FIG. 1 is a diagram illustrating an example of a communication device. to FIG. 2 is a diagram illustrating another example of a communication device.

FIG. 3 is a diagram illustrating an example of a security initialization process between a mobile device A functioning as a master communication device and a mobile device B functioning as a slave communication device.

FIG. 4 is a flowchart illustrating an example of a communication method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

The term “communication device” used herein may include a mobile terminal As a non-exhaustive illustration only, the communication device described herein may refer to mobile devices such as a cellular phone, a personal digital assistant (PDA), a digital camera, a portable game console, an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, a printer, and the like capable of wireless communication or communication consistent with that disclosed therein. Additionally, a mouse, a headset, and the like, including a Bluetooth communication function may perform a Bluetooth communication with other devices and thus may be included in the communication device herein.

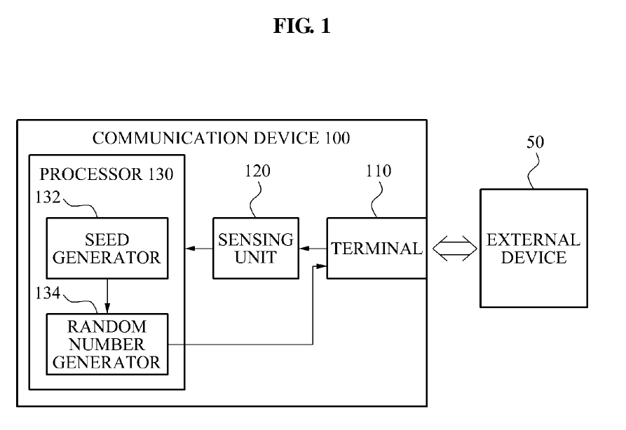

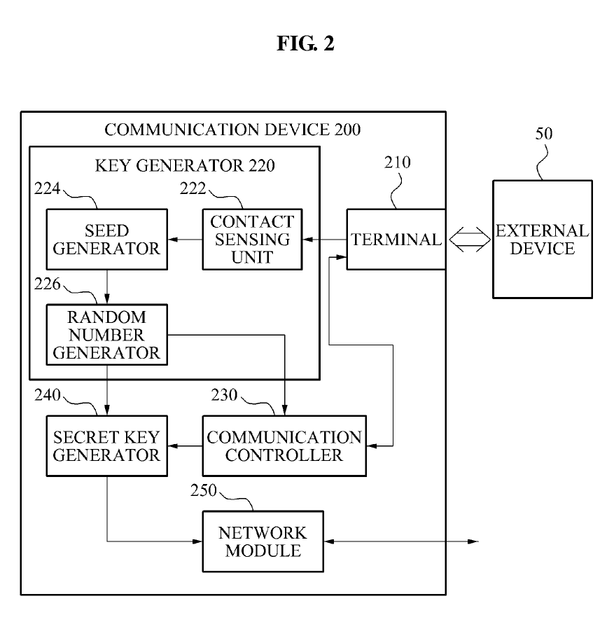

FIG. 1 illustrates an example of a communication device 100.

Referring to FIG. 1, for example, the communication device 100 includes a terminal 110, a sensing unit 120, and a processor 130.

The terminal 110 denotes a communicable physical terminal that may be provided to the communication device 100 to contact an external device 50, and may transmit and receive information to and from the external device 50.

A physical contact of the external device 50 may be maintained until a first key generated by the processor 130 is transferred to the external device 50 via the terminal 110, and a second key is received from the external device 50 via the terminal 110. The external device 50 may include a mobile terminal, for example, a notebook, a mobile phone, a PMP, a PDA, and the like, and various types of devices, for example, a mouse, a headset, and the like, that may perform a communication with the mobile terminal. However, the external device 50 is not limited to these examples.

The terminal 110 may include, for example, a contact-type terminal used in a mobile phone and a subscriber identification module (SIM) card, a universal serial bus (USB) terminal, a human body communication terminal, and the like. Other suitable terminals may be used as well.

According to an example, where two communication devices make a physical contact with each other, the two communication devices may be paired. Accordingly, a user may not need to input a personal identification number (PIN) and the like in order to pair the two communication devices. Even a communication device not including a separate input/output (I/O) unit may perform a pairing. Conversely, in schemes where a PIN is to be input by the user to communication devices, an I/O unit may be installed in the communication devices.

The sensing unit 120 may sense the physical contact of the external device 50, and recognize a contact between the terminal 110 of the communication device 100 and a terminal (not shown) of the external device 50. In one example, the sensing unit 120 may include contact sensors.

When terminals of two devices make a physical contact with each other, the sensing unit 120 may sense the physical contact and request the processor 130 to generate the first key. That is, in response to the sensed physical contact, the sensing unit 120 may trigger the processor 130 to generate the first key.

Upon receiving the request from the sensing unit 120 in response to the sensed physical contact, the processor 130 may generate the first key and transfer the first key to the external device 50. The processor 130 may receive the second key from the external device 50, and generate a link key using the first key and the second key.

According to an example, a communication device may sufficiently extend a length of a first key and a length of a second key that are generated for a secured communication, and thus security may be enhanced. For example, the communication device may extend the length of the first key and the length of the second to key to be 128 bits. Accordingly, it may be difficult to gain unauthorized access into the communication device using a brute-force tool such as BTCrack. A physical contact between two communication devices should actually occur for a pairing and thus it may be difficult to remotely attack the communication between the two communication devices.

The processor 130 transfers the first key to the external device 50 via the terminal 110, and receives the second key from the external device 50 via the terminal 110.

The processor 130 may generate shared secret information that is utilized by a communication protocol while performing a communication between the communication device 100 and the external device 50. For example, the processor 130 may generate a link key for a Bluetooth connection. The link key may include 128 bits or more.

For a secured communication between communication devices, sharing of secret information may be kept to a minimum. To share the secret information, a pairing process may be performed while performing a Bluetooth connection between the communication devices. In this example, the link key may be shared.

The secret information shared between the communication devices may be used to induce a cryptographic key for a secured communication between the two communication devices. In the case of general Bluetooth, the link key may be obtained by manually inputting a key between the two communication devices in a pairing start operation.

The processor 130 includes a seed generator 132 and a random number generator 134. In response to the sensed physical contact between the external device 50 and the terminal 110, the seed generator 132 may generate a seed key. The random number generator 134 may randomly generate the first key using the seed key. That is, the seed generator 132 may generate the seed key that is used as an initial value for the random number generator 134 to generate a random number. The seed key may be generated using a clock included in the processor 130.

As described in the examples above, the processor 130 may generate the link key using the first key and the second key. For example, the processor 130 may generate the link key by performing an exclusive OR (XOR) operation on the first key and the second key. Also, the processor 130 may generate the link key according to, for example, various types of logical operations, arithmetic operations, combinations of logical operations and arithmetic operations, and the like, using the first key and the second key.

The processor 130 may utilize, as the cryptographic key for the communication with the external device 50, the link key that is generated using the first key and the second key. The processor 130 may perform a Bluetooth authentication with respect to the external device 50 by utilizing, as a link key for the Bluetooth communication, the link key that is generated using the first key and the second key.

According to an example, secret information that is used for a secured communication may be generated and transferred by a physical contact between a master communication device and a slave communication device that are selected to communicate with each other. Accordingly, where a communication between the master communication device and the slave communication device is remotely attacked and, in this instance, an attacking communication device spoofs the slave communication device and requests the master communication device for a re-pairing due to a loss of a key, the pairing may not be made without an actual physical contact. Since a link key may not be obtained using BTCrack because monitoring of the pairing between the master communication device and the salve communication device cannot be performed remotely, it is possible to prevent or deter the remote attack against the communication between the above two communication devices.

FIG. 2 illustrates another example of a communication device 200.

Referring to FIG. 2, for example, the communication device 200 includes a terminal 210, a key generator 220, a communication controller 230, a secret key generator 240, and a network module 250.

The terminal 210 denotes a communicable physical terminal that may be provided to the communication device 200 to make a contact with an external device 50 and may transmit and receive information to and from the external device 50.

A physical contact between the external device 50 and the communication device 200 may be maintained until a first key generated by the key generator 220 is transferred to the external device 50 via the terminal 210, and a second key is received by the communication device from the external device 50 via the terminal 210. The external device 50 may include a mobile terminal, for example, a notebook, a mobile phone, a PMP, a PDA, and the like, and various types of devices, for example, a mouse, a headset, and the like, that may perform a communication with the mobile terminal. The examples are non-exhaustive, and other mobile terminals may be used.

The terminal 210 may include, for example, a contact-type terminal used in a mobile phone and a SIM card, a USB terminal, a human body communication terminal, and the like. However, the terminal 210 is not limited to these examples.

In response to the sensed physical contact between the external device 50 and the terminal 210, the key generator 220 may generate the first key. The key generator 220 includes a contact sensing unit 222, a seed generator 224, and a random number generator 226.

The contact sensing unit 222 may include, for example, various types of contact sensors that may recognize a contact between the terminal 210 of the communication device 200 and a terminal (not shown) of the external device 50. In response to the sensed physical contact, the contact sensing unit 222 may transmit a signal to the seed generator 224 and request the seed generator 224 to generate a seed key.

Thus, where the terminal 110 of the communication device 200 and the terminal of the external device 50 make a physical contact with each other, the contact sensing unit 222 may recognize the physical contact and transmit the signal to the seed generator 224 to generate the seed key for generating of the first key.

The seed generator 224 may include a clock and generate the seed key using a current time. For example, the seed generator 224 may generate the seed key that is in a form of a bitstream indicating the current time, and may transfer the generated seed key to the random number generator 226.

The random number generator 226 may randomly generate the first key using the seed key that is provided from the seed generator 224. The first key generated by the random number generator 226 may be provided to the communication controller 230 and the secret key generator 240.

The communication controller 230 may perform a key exchange with the external device 50 through the physical contact. The communication controller 230 may transmit, via the terminal 210, the generated first key to the external device 50 contacted on the terminal 210, and may receive the second key from the external device 50 via the terminal 210. The second key may also be generated using the same or similar scheme as described above with reference to FIG. 1, for example.

The secret key generator 240 may generate a first link key using the first key of the communication device 200 that is provided from the random number generator 226, and using the second key of the external device 50 that is received via the communication controller 230. The first link key may be generated using an operation between the first key and the second key, for example, a logical operation such as an XOR operation, an arithmetic operation with respect to a particular equation, or a combination of the arithmetic operation and the logical operation. Other suitable operations may be used as well.

The network module 250 may perform a general communication between communication devices, and may receive the first key from the secret generator 240 to perform a secured communication with the external device 50 using the first key.

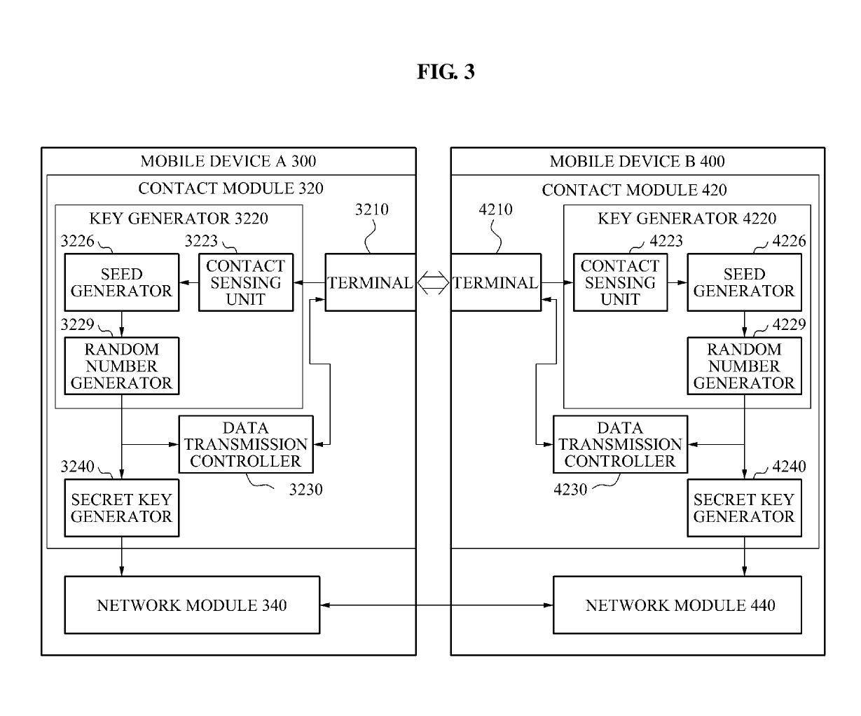

FIG. 3 illustrates an example of a security initialization process between a mobile device A (also referred to as a communication device 300) functioning as a master communication device and a mobile device B (also referred to as a communication device 400) functioning as a slave communication device.

By way of example, FIG. 3 illustrates the communication device 300 including a contact module 320 and a network module 340. The communication device 400 includes a contact module 420 and a network module 440. The contact modules 320 and 420 denote a module that may generate a key for a secured communication through a physical contact. The contact module 320 includes a terminal 3210, a key generator 3220, a data transmission controller 3230, and a secret key generator 3240. These features may perform similar functions to those of the terminal 210, the key generator 220, the communication controller 230, and the secret key generator 240, respectively, as discussed above and illustrated by the example shown in FIG. 2. The contact module 420 includes a terminal 4210, a key generator 4220, a data transmission controller 4230, and a secret key generator 4240. These features may perform the functions similar to those of the terminal 210, the key generator 220, the communication controller 230, and the secret key generator 240, respectively, as addressed above.

Similar to the network module 250 of FIG. 2, each of the network modules 340 and 440 may perform a communication between general communication devices, and may receive a first key or a second key that is generated by each of the communication devices, and perform a secured communication with an external device (not shown) using the first key and the second key.

Where the terminal 3210 of the communication device 300, functioning as the master communication device, makes a physical contact with the terminal 4210 of the communication device 400, functioning as the slave communication device, for a security initialization, contact sensing units 3223 and 4223 may sense the physical contact and transmit a signal to seed generators 3226 and 4226, respectively, to request a seed generation.

The seed generators 3226 and 4226 may include a clock. The seed generators 3226 and 4226 receive the request from the contact sensing units 3223 and 4223 may each generate a seed key using a current time of physical contact of the communication devices 300 and 400, respectively. Each generated the seed key may be in a form of bitstream indicating a current time and each seed generator may transmit the respective seed key to respective random number generators 3229 and 4229.

The random number generator 3229 of the communication device 300 receiving the seed key from the seed generator 3226 may randomly generate the first key.

The random number generator 4229 of the communication device 400 may randomly generate the second key using the seed key transmitted from the seed generator 4226.

The first key generated by the random number generator 3229 may be provided to the secret key generator 3240 and then be used to generate the first link key. The second key generated by the random number generator 4229 may be provided to the secret key generator 4240 and then be used to generate the first link key.

The generated first key and the second key may be transmitted to corresponding communication devices via the terminals 3210 and 4210, respectively. Specifically, the first key generated by the communication device 300 functioning as the master communication device may be transmitted to the communication device 400 functioning as the slaving communication device. The second key generated by the communication device 400 may be transmitted to the communication device 300.

The second key may be provided to the secret key generator 3240 and the first key may be provided to the secret key generator 4240 whereby the link key may be generated through a logical operation or an arithmetic operation using the first key and the second key.

For example, the secret key generator 3240 of the communication device 300 receiving the second key from the communication device 400 may generate the link key through an operation between the first key generated by the random number generator 3229 and the received second key. The operation may be, for example, a logical operation such as an XOR operation, an arithmetic operation with respect to a particular equation, or a combination of the logical operation and the arithmetic operation.

The generated link key may be used as a cryptographic key to encrypt a communication signal for a communication with a correspondent communication device. For example, in a Bluetooth communication, where a communication between the communication device 300, functioning as the master communication device, and the communication device 400, functioning as the slave communication device, is performed, the link key may be used as the cryptographic key to encrypt a data packet. The link key may be used as a cryptographic communication key as is. Alternatively, a new cryptographic communication key, generated by using the link key, may be used.

According to an example, secret information used for a secured communication may be generated and be transferred by a physical contact between a master communication device and a slave communication device that desire to communicate with each other. Accordingly, where a remote attack is made against a communication between the master communication device and the slave communication device and in this instance, an attacking communication device spoofs the slave communication device and requests the master communication device for a re-pairing due to a loss of a key, the pairing may not be made without an actual physical contact. Since the link key may not be obtained using BTCrack because monitoring of the pairing between the master communication device and the slave communication device is prevented or deterred from being performed remotely, it is possible to prevent or deter the remote attack against the communication between the above two communication devices.

The Bluetooth communication may share a key by inputting the key agreed upon offline by users of two Bluetooth devices/communication devices into input units of communication devices, or by publishing a PIN in a manual for the users in a release process.

During a pairing process, a link key may be generated using the shared key, and whether the two communication devices generate the same link key may be authenticated. Where the authentication succeeds, a cryptographic key may be generated using the link key and a secured Bluetooth communication may be performed.

According to an example, a communication device may employ, as a Bluetooth link key or a cryptographic key for a communication between communication devices, a cryptographic key that is generated through a physical contact between the communication devices, instead of a PIN sharing process and a pairing process using a key. Accordingly, there is no need to input the key agreed upon offline by the communication devices into inputs units of the communication devices.

In addition, a probability of an unauthorized user gaining access due to a shortened key length may decrease. Since a secret key and a link key may be generated only through a physical contact, a remote hacking may not occur within a communication range.

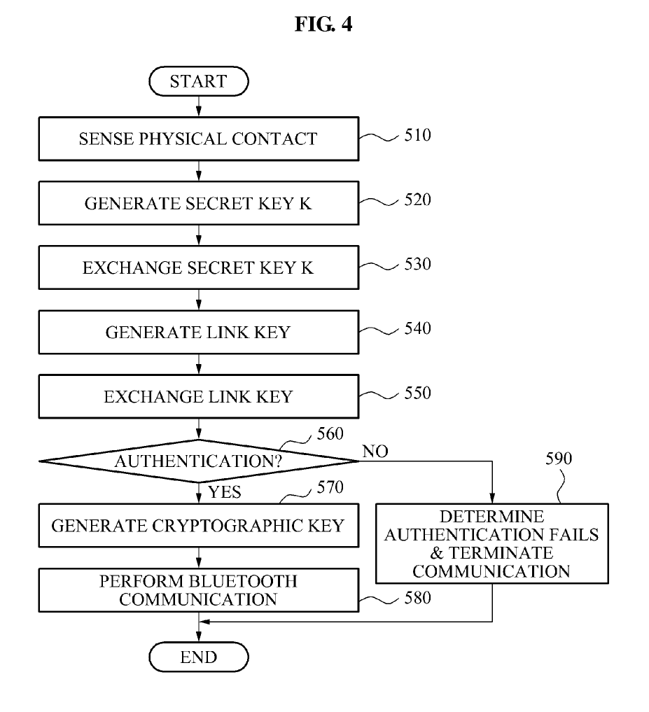

FIG. 4 illustrates a flowchart of an example of a communication method.

In operation 510, two communication devices that are selected to perform a secured communication sense a physical contact between the two communication devices. The physical contact may be made via a terminal. In this example, the terminal denotes a communicable physical terminal that may be provided to a corresponding communication device to make a contact with a correspondent communication device and may transmit and receive information to and from the correspondent communication device.

As described above, the physical contact may be maintained until a first key generated by a key generator of the communication device is transferred to the correspondent communication device via the terminal of the communication device, and a second key is received by the communication device from the correspondent communication device via the terminal of the communication device. The correspondent communication device may include a mobile terminal, for example, a notebook, a mobile phone, a PMP, a PDA, and the like, and various types of devices, for example, a mouse, a headset, and the like, that may perform a communication with the mobile terminal Other examples of mobile terminals may be used as well.

The terminal may include, for example, a contact-type terminal used in a mobile phone and a SIM card, a USB terminal, a human body communication terminal, and the like. However, the terminal is not limited to these examples.

According to an example, where two communication devices make a physical contact with each other, the two communication devices may be paired. Accordingly, a user inconvenience caused by absence of an I/O unit according to a slimness of the communication devices may be avoided. Since a key length may be sufficiently extended, it is also possible to prevent or deter an unauthorized user gaining access using a brute-force tool such as BTCrack.

A Bluetooth device, for example, a mobile phone, a mouse, a headset, and the like, may be small and thus may include an insufficient function for a user to arbitrarily input a text and the like. A key may be needed for a Bluetooth pairing. In the case of the headset, which may not have an input function, four digit numbers may be generally used for the key. The key is a value input in a manufacturing process and thus the user may not be able to change the key.

According to an example, a communication device may perform a pairing through physical contact with another communication device. Where a single user desires to share secret information between two mobile communication devices, it is possible to provide the user both user convenience and secured communication.

Where two communication devices make an actual physical contact with each other, a remote attack against the communication between the two communication devices may be prevented or deterred.

The physical contact may be sensed by a contact sensing unit. In response to the physical contact being sensed by a contact sensing unit, each of the communication devices may generate a secret key K in operation 520. Generation of the secret key K may be initiated by sensing, the physical contact at the contact sensing unit of each of the communication devices, as noted above, and by transmitting a signal to the seed generator to request a seed generator.

The seed generator receiving the request may include a clock and generate a seed key using a current time of physical contact of a corresponding communication device. The seed key may be in a form of a bitstream indicating a current time. The seed generator may transmit the generated seed key to a random number generator.

The random number generator receiving the seed key from the seed generator may randomly generate the secret key K.

The secret key K generated by the random number generator may be provided to a secret key generator and be used to generate a link key.

In operation 530, the secret key K generated by one communication device and the secret key K generated by the other communication device may be exchanged with each other via corresponding terminals. For example, a secret key of a master communication device may be transmitted to a slave communication device, and a secret key of the slave communication device may be transmitted to the master communication device.

In operation 540, the link key is generated according to a logical operation or an arithmetic operation between the secret keys K of the communication devices by providing the secret key K received from the correspondent communication device and the secret key generated by the random number generator of the communication unit to the secret key generator. For example, the secret key generator of the master communication device receiving the secret key from the slave communication device may perform an XOR operation for the secret key generated by the random number generator of the master communication device and the received secret key of the slave communication device to generate the link key.

The link key may be generated according to various types of logical operations, arithmetic operations, combinations of logical operations and arithmetic operations, and the like using the secret key of the master communication device and the secret key of the master communication device. However the operations by which the link key may be generated are not limited to the examples above.

In operation 550, the generated link keys are exchanged between the two communication devices.

In operation 560, each of the two communication devices determines whether to authenticate a correspondent communication device using the link key. The authentication may be determined depending on whether the link keys of the two communication devices are identical to each other. Where the link keys are identical to each other, a cryptographic key for a communication between the two communication devices is generated using the link key in operation 570, and a Bluetooth communication is performed in operation 580.

The cryptographic key generated using the link key in operation 570 may be utilized to encrypt various types of data transmitted and received while performing the communication between the communication devices. The cryptographic key may be generated using various types of algorithms.

Conversely, where the link keys are different from each other, the communication devices determine the authentication fails and immediately terminate the communication in operation 590.

The link key generated in operation 540 may be utilized as the cryptographic key for the communication between the communication devices. In this example, data to be transmitted may be encrypted using the link key. In such an event, operations 550 through 580 may not be performed.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD-ROM disks and DVDs; magneto-optical media such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication device comprising:
a terminal;
a sensing unit configured to sense a physical contact between the terminal and an external device; and
a processor configured to:
generate a first key in response to sensed physical contact, to transfer the first key to the external device;
receive a second key from the external key; and
generate a link key using the first key and the second key.

2. The communication device of claim 1, wherein the processor is further configured to:
transfer the first key to the external device via the terminal; and
receive the second key from the external device via the terminal.

3. The communication device of claim 2, wherein the physical contact is maintained until the first key is transferred to the external device, and the second key is received from the external device.

4. The communication device of claim 1, wherein the processor comprises:
a seed generator configured to generate a seed key in response to the sensed physical contact; and
a random number generator configured to randomly generate the first key using the seed key.

5. The communication device of claim 1, wherein the processor is further configured to generate the link key by performing an exclusive OR (XOR) operation for the first key and the second key.

6. A communication device comprising:
a terminal;
a key generator configured to generate a first key in response to sensing a physical contact between the terminal and an external device;
a data transmission controller configured to:
transmit, via the terminal, the first key to the external device contacting the terminal; and
receive a second key from the external device via the terminal; and
a secret key generator configured to generate a first link key using the first key and the second key.

7. The communication device of claim 6, wherein the key generator comprises:
a seed generator configured to generate a seed key using a current time;
a contact sensing unit configured to transmit a signal to the seed generator in response to the sensed physical contact; and
a random number generator configured to randomly generate the first key using the seed key.

8. A communication system comprising:
a first communication device including a first terminal; and
a second communication device including a second terminal,
wherein the first communication device and the second communication device are paired with each other by physical contact between the terminal of the first communication device and the terminal of the second communication device, to enable communication between the first communication device and second communication device.

9. The communication system of claim 8, wherein the first communication device further comprises:
a first key generator configured to generate a first key in response to sensing a physical contact between the first communication device terminal and the second communication device;
a first data transmission controller configured to:
transmit, via the first communication device terminal, the first key to the second communication device; and
receive a second key from the second communication device via the first communication device terminal; and
a first secret key generator configured to generate a first link key using the first key and the second key.

10. The communication system of claim 9, wherein the second communication device further comprises:
a second key generator configured to generate a second key in response to sensing a physical contact between the second communication device terminal and the first communication device;
a second data transmission controller configured to:
transmit, via the second communication device terminal, the second key to the first communication device; and
receive the first key from the first communication device via the second communication device terminal; and
a second secret key generator configured to generate a second link key using the first key and the second key.
